(19) United States
(12) Patent Application Publication
(10) Pub. No.: US 2004/0214091 A1
(43) Pub. Date: Oct. 28, 2004

(54) Electrolyte for a lithium battery and a lithium battery comprising the same

(75) Inventors: Hyun-Jeong Lim, Incheon-city (KR); Eui-Hwan Song, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/819,268

(22) Filed: Apr. 7, 2004

(30) Foreign Application Priority Data
Apr. 28, 2003 (KR) 2003-26846

(51) Int. Cl. H01M 10/40

(52) U.S. Cl. 429/326; 429/340; 429/343

(57) ABSTRACT

An electrolyte of a lithium battery includes a non-aqueous organic solvent, a lithium salt, and a compound additive such as a sulfone-based compound, a carbonate-based compound, and a sulfoxide compound that substantially include aromatic hydrocarbon groups. The lithium battery utilizing the electrolyte of the present invention has improved electrochemical properties such as capacity at a high rate and safety of the battery during overcharge.

### CROSS-REFERENCE TO RELATED APPLICATIONS

This application claims priority to Korean patent application No. 2003-26846 filed in the Korean Intellectual Property Office on Apr. 28, 2003, the disclosure of which is incorporated herein by reference.

### BACKGROUND OF THE INVENTION

1. Field of the Invention

The present invention relates to a non-aqueous electrolyte and a lithium battery comprising the same, and more particularly, to a non-aqueous electrolyte for a lithium battery that improves its electrochemical properties and overcharge characteristics.

2. Description of the Related Art

Due to recent trends toward more compact and lighter portable electronic equipment, there has been a growing need to develop a high performance and large capacity battery to power this portable electronic equipment. A lithium secondary battery, having an average discharge potential of 3.7 V (i.e., a battery having substantially a 4 V average discharge potential) is considered to be an essential element in the digital generation, since it is an indispensable energy source for portable digital devices such as cellular telephones, notebook computers, and camcorders (i.e., the “3C” devices).

There has been extensive research on effective safety characteristics of batteries, such as the ability to prevent overcharge. When a battery is overcharged, an excess of lithium ions is deposited on the positive electrode, and an excess of lithium ions is also inserted into the negative electrode, which causes the positive and negative electrodes to become thermally unstable. An eruptive explosion may occur from the decomposition of the electrolytic organic solvent, and the thermal runaway that occurs causes serious safety concerns for batteries.

To overcome the above problems, it has been suggested that an aromatic compound such as an oxidation-reduction additive agent (“redox shuttle”) be added to the electrolyte. For example, U.S. Pat. No. 5,709,968 discloses a non-aqueous lithium ion secondary battery to prevent thermal runaway resulting from an overcharge current by using a benzene compound such as 2,4-difluoroanisole. U.S. Pat. No. 5,879,834 discloses a method for improving battery safety by using a small amount of an aromatic compound such as biphenyl, 3-chlorothiophene, furan, and the like, which is polymerized electrochemically to increase the internal resistance of a battery during unusual overvoltage conditions. Such redox shuttle additives increase the temperature inside the battery early due to heat produced by the oxidation-reduction reaction, and close pores of a separator through quick and uniform fusion of the separator to inhibit an overcharge reaction. The polymerization reaction of these redox shuffle additives consumes the overcharge current to improve battery safety.

However, the polymerization of these redox shuttle additives cannot sufficiently eliminate the overcharge current. In addition, decomposition of the additives may cause gas generation inside the battery, and thus, the battery swells. Therefore, improvements in the safety of the battery are limited when using the redox shuttle additives. Additionally, some redox shuttle additives have a deleterious effect on electrochemical properties such as high temperature or cycle life characteristics.

However, the above-described additives for preventing overcharge are not sufficient to satisfy high level safety requirements due to a high capacity demand of the consumer. Accordingly, the development of new additives to prevent overcharge and which ensure safety of a high capacity battery is urgently required.

### SUMMARY OF THE INVENTION

To solve the problems stated above, it is an aspect of the present invention to provide an electrolyte of a lithium battery with improved safety and electrochemical characteristics.

It is another aspect of the present invention to provide a lithium battery with improved safety and electrochemical characteristics.

To accomplish the aspects of the present invention, the present invention provides an electrolyte of a lithium battery comprising an organic solvent; lithium salts; and an additive compound represented by the following formulas (1) to (5) and mixtures thereof:

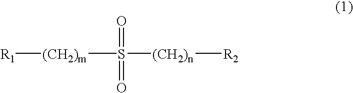

where R₁ and R₂ are independently selected from the group consisting of an alkyl and an aromatic hydrocarbon of the following formula (6) (if either of R₁ and R₂ is an alkyl, the other one is essentially an aromatic hydrocarbon of the following formula (6)), and m and n are integers of 0 to 3, preferably 1 to 2 (m and n are not 0 simultaneously);

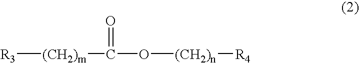

where R₃ and R₄ are independently selected from the group consisting of an alkyl and an aromatic hydrocarbon of the following formula (6), and m and n are integers of 0 to 3, preferably

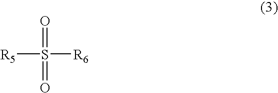

where R₅ and R₆ are independently selected from the group consisting of an alkyl and an aromatic hydrocarbon of the following formula (6) (if either of R₅ and R₆ is an alkyl, the other one is essentially an aromatic hydrocarbon of the following formula (6));

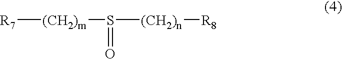

where R₇ and R₈ are independently selected from the group consisting of an alkyl and an aromatic hydrocarbon of the following formula (6) (if either of R₇ and R₈ is an alkyl, the other one is essentially an aromatic hydrocarbon of the following formula (6)), and m and n are integers of 0 to 3, preferably 1 to 2;

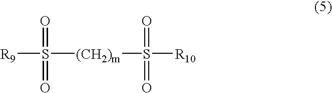

where R₉ and R₁₀ are independently selected from the group consisting of an alkyl and an aromatic hydrocarbon of the following formula (6) (if either of R₉ and R₁₀ is an alkyl, the other one is essentially an aromatic hydrocarbon of the following formula (6)), and m is a integer of 0 to 3, preferably 1 to 2; and

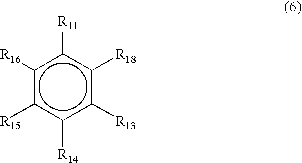

where R₁₁ and R₁₆ are independently selected from the group consisting of hydrogen, halogen, alkyl, alkoxy, hydroxy, and carboxyl.

The present invention further provides a lithium battery including the electrolyte.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a prismatic lithium secondary battery cell;

FIGS. 2A to 2C are graphs illustrating measurement results of cyclic voltammetry with respect to electrolytes of Examples 1 and 6 of the present invention and Comparative Example 1, respectively; and

FIGS. 3A to 3G are graphs illustrating current, voltage, and cell temperature of battery cells according to Examples 1 to 6 of the present invention and Comparative Example 1 when overcharging, respectively.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. As will be realized, the invention is capable of modification in various respects, all without departing from the invention. Accordingly, the drawings and description are to be regarded as illustrative in nature, and not limiting in any respect.

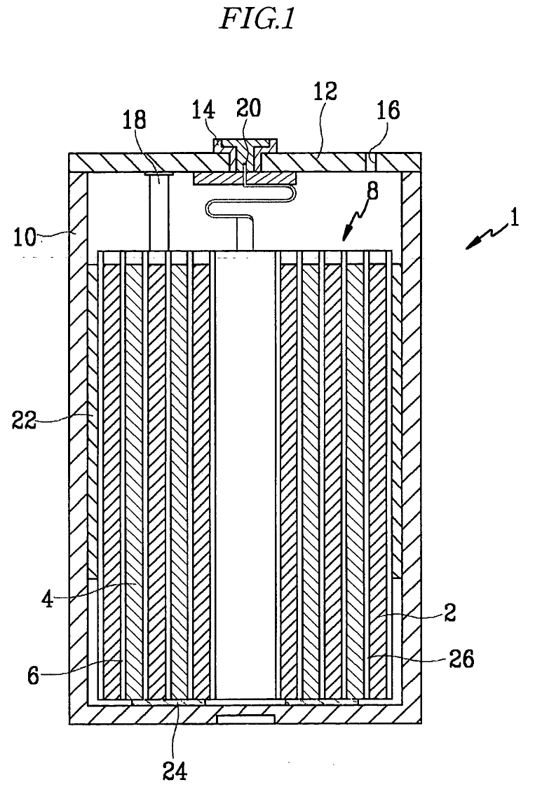

A cross-sectional view of a general non-aqueous Li-ion cell is shown in FIG. 1. The Li-ion cell 1 is fabricated by inserting an electrode assembly 8 including a positive electrode 2, a negative electrode 4, and a separator 6 between the positive and negative electrodes into a battery case 10. An electrolyte 26 is injected into the battery case 10 and impregnated into the separator 6. The upper part of the case 10 is sealed with a cap plate 12 and a sealing gasket 14. The cap plate 12 has a safety vent 16 to release pressure. A positive electrode tab 18 and a negative electrode tab 20 are respectively attached on the positive electrode 2 and the negative electrode 4. Insulators 22 and 24 are installed on the lower part and the side part of the electrode assembly 8 to prevent a short circuit in the battery.

In a lithium battery, the temperature of the battery increases abruptly because of overcharge due to incorrect operation or break-down of the battery, or a short circuit occurrence due to a defect in battery design, so that thermal runaway takes place. During overcharge, an excessive amount of lithium ions are released from the positive electrode and deposited on the surface of the negative electrode to render the positive and negative electrodes unstable. As a result, exothermic reactions such as pyrolysis of the electrolyte, reactions between the electrolyte and lithium, an oxidation reaction of the electrolyte on the positive electrode, a reaction between the electrolyte and oxygen gas that is generated from the pyrolysis of the positive active material, and the like, rapidly increase the temperature inside the battery to cause thermal runaway, and thus, the generation of fire and smoke.

An electrolyte of the present invention improves the safety of a lithium battery during overcharge by using an additive compound selected from the group consisting of compounds represented by the following formulas (1) to (5), and a mixture thereof:

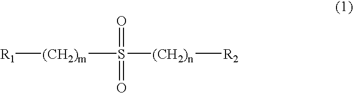

where R₁ and R₂ are independently selected from the group consisting of an alkyl and an aromatic hydrocarbon of the following formula (6) (if either of R₁ and R₂ is an alkyl, the other one is essentially an aromatic hydrocarbon of the following formula (6)), and m and n are integers of 0 to 3, preferably 1 to 2 (m and n are not 0 simultaneously);

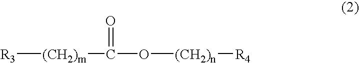

where R₃ and R₄ are independently selected from the group consisting of an alkyl and an aromatic hydrocarbon of the following formula (6), and m and n are integers of 0 to 3, preferably

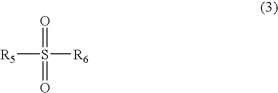

where R₅ and R₆ are independently selected from the group consisting of an alkyl and an aromatic hydrocarbon of the following formula (6) (if either of R₅ and R₆ is an alkyl, the other one is essentially an aromatic hydrocarbon of the following formula (6));

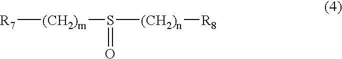

where R₇ and R₈ are independently selected from the group consisting of an alkyl and an aromatic hydrocarbon of the following formula (6) (if either of R₇ and R₈ is an alkyl, the other one is essentially an aromatic hydrocarbon of the following formula (6)), and m and n are integers of 0 to 3, preferably 1 to 2; and

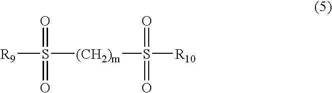

where R₉ and R₁₀ are independently selected from the group consisting of an alkyl and an aromatic hydrocarbon of the following formula (6) (if either of R₉ and R₁₀ is an alkyl, the other one is essentially an aromatic hydrocarbon of the following formula (6)), and m is an integer of 0 to 3, preferably 1 to 2; and

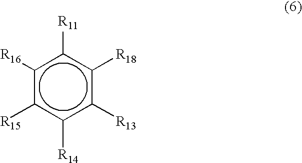

where R₁₁ and R₁₆ are independently selected from the group consisting of hydrogen, halogen, alkyl, alkoxy, hydroxy, and carboxyl.

In the present specification, it is preferable that the alkyl and alkoxy have 1 to 3 carbons, more preferably 1 to 2 carbons.

The compounds represented by formulas (1) to (5) initiate polymerization at more than 4.5 V, and form a coating layer on a surface of the electrode to decrease internal resistance between the positive and the negative electrodes. The coating layer formed through polymerization of the compounds of formula (1) to (5) may consume an overcharge current, and thus improve safety of the battery through an oxidation-reduction reaction.

Exemplary compounds represented by formulas (1) to (5) preferably include a dibenzyl sulfoxide, 4,4-dicarboxyldiphenyl sulfone, bisphenyl sulfonyl methane, phenyl sulfone, bis(4-fluorophenyl) sulfone, 4-chlorophenyl phenyl sulfone, methyl phenyl sulfone, ethyl phenyl sulfone, benzyl benzoate, and the like.

The compound additive is added in an amount of 0.1 to 50 wt %, preferably 1 to 10 wt %, and more preferably 0.1 to 5 wt %, based on the total amount of the electrolyte. The addition effect is not realized sufficiently when the compound is used in an amount of less than 0.1 wt %, and the cycle life characteristics of the battery are decreased when the compound is used in an amount exceeding 50 wt %.

The compound additive is added to a non-aqueous organic solvent including a lithium salt. The lithium salt acts as a supply source of lithium ions in the battery, enabling the basic operation of a lithium battery. The non-aqueous organic solvent plays a role of a medium wherein ions capable of participating in the electrochemical reaction are mobilized.

The lithium salt is preferably at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein x and y are natural numbers), LiCl, and LiI.

The concentration of the lithium salt preferably ranges from 0.6 to 2.0 M, more preferably 0.7 to 1.6 M. When the concentration of the lithium salt is less than 0.6 M, the electrolyte performance deteriorates due to its ionic conductivity. When the concentration of the lithium salt is greater than 2.0 M, the lithium ion mobility decreases due to an increase of the electrolyte viscosity.

The non-aqueous organic solvent may include a carbonate, an ester, an ether, or a ketone. Examples of carbonates include dimethyl carbonate (DMC), diethyl carbonate (DEC), dipropyl carbonate (DPC), methylpropyl carbonate (MPC), ethylpropyl carbonate (EPC), methylethyl carbonate (MEC) methylisopropyl carbonate, ethylbutyl carbonate (EBC), diisopropyl carbonate (DIC), dibutyl carbonate (DBC), ethylene carbonate (EC), propylene carbonate (PC), butylene carbonate (BC), and the like. Examples of esters may include γ-butyrolactone (γ-BL), n-methyl acetate, n-ethyl acetate, n-propyl acetate, and other suitable esters. Examples of ethers may include dibutyl ether, dimethyl ether, tetrahydrofuran, and other suitable ethers. Examples of ketones include polymethylvinyl ketone and other suitable ketones. However, the non-aqueous organic solvent is not limited to the above solvents.

It is preferable to use a mixture of a linear carbonate and a cyclic carbonate. The cyclic carbonate and the linear carbonate are preferably mixed together in a volume ratio ranging from about 1:1 to about 1:9 cyclic carbonate to linear carbonate. When the cyclic carbonate and the linear carbonate are mixed in the above volume ratio, and the mixture is used as an electrolyte, the electrolyte performance may be enhanced.

In addition, the electrolyte of the present invention may further include mixtures of the carbonate solvents and aromatic hydrocarbon solvents of formula (7):

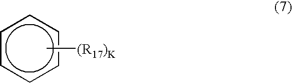

where R₁₇ is a halogen, or a C₁ to approximately a C₁₀ alkyl, and k is an integer of 0 to approximately 6.

Examples of aromatic hydrocarbon solvents include benzene, chlorobenzene, nitrobenzene, fluorobenzene, toluene, fluorotoluene, trifluorotoluene, xylene, or other suitable aromatic solvents. The carbonate solvents and the aromatic hydrocarbon solvents are preferably mixed together in a volume ratio ranging from about 1:1 to about 30:1 carbonate solvent to aromatic hydrocarbon solvent. When a carbonate solvent and an aromatic hydrocarbon solvent are mixed with each other in the aforementioned volume ratio, and the mixture is used as an electrolyte, the electrolyte performance may be enhanced.

The electrolyte of the present invention is usually prepared by adding the compound additive to an organic solvent in which lithium salts dissolve. The addition order of the compound additive and lithium salts to the organic solvent is not important.

The present invention provides a lithium battery comprising the electrolyte. The lithium battery of the present invention uses a material that reversibly intercalates/deintercalates the lithium ions (a lithiated intercalation compound), as a positive active material. Examples of the material that reversibly intercalates/deintercalates the lithium ions are a lithium-containing metal oxide or a lithium-containing calcogenide compound such as LiCoO₂, LiNiO₂, LiMnO₂, LiMn₂O₄, and LiNi_{1-x-y}COₓM_{y}O₂ (0≦x≦1, 0≦y≦1, 0≦x+y≦1, M is a metal such as Al, Sr, Mg, La, or the like).

The lithium battery of the present invention uses a lithium metal, a lithium-containing alloy, a carbonaceous material that reversibly intercalates/deintercalates the lithium ions, or a material that may reversibly form a lithium-containing compound, as a negative active material. Examples of a carbonaceous material that reversibly intercalates/deintercalates the lithium ions are crystalline or amorphous carbon or a carbon complex.

A lithium battery is prepared by the following process: the compound additive is added to a lithium salt-containing organic solution to prepare an electrolyte composition; a separator and an insulating resin with a network structure are interposed between a negative electrode and a positive electrode that are fabricated by a conventional process, and the whole is wound or stacked to fabricate an electrode assembly; then, the electrode assembly is inserted into a battery case followed by sealing. The separator is a polyethylene or polypropylene monolayered separator, a polyethylene/polypropylene double layered separator, a polyethylene/polypropylene/polyethylene three layered separator, or a polypropylene/polyethylene/polypropylene three layered separator. A cross-sectional structure of the lithium battery prepared by the above process is shown in FIG. 1.

The electrolyte of the present invention may be applied to all types of lithium batteries, including a lithium primary battery and a lithium secondary battery.

The lithium battery may provide improved safety characteristics such as significant overcharge properties compared with a conventional non-aqueous electrolyte.

The following Examples further illustrate the present invention in detail, but are not to be construed to limit the scope thereof.

### EXAMPLE 1

LiPF₆ was added to a non-aqueous organic solvent, including ethylene carbonate/ethylmethyl carbonate/propylene carbonate/fluorobenzene (EC/EMC/PC/FB) in a volume ratio of 30:55:5:10 to form a 1.3 M LiPF₆ solution. 0.25 g of dibenzyl sulfoxide was added to 5 g of the resultant mixed solution to prepare an electrolyte.

LiCoO₂ having an average particle diameter of 10 μm as a positive active material, SUPER P (acetylene black) as a conductive agent, and polyvinylidenefluoride (PVdF) as a binder were mixed in a weight ratio of 94:3:3 in N-methyl-2-pyrrolidone (NMP) to prepare a positive slurry. The slurry was coated on an aluminum foil, dried, and compressed by a roll press, thus manufacturing a positive electrode having a width of 4.9 cm and a thickness of 147 μm. Mesocarbon fiber (MCF from PETOCA company) as a negative active material, oxalic acid, and PVdF as a binder were mixed in a weight ratio of 89.8:0.2:10 to prepare a negative slurry. The slurry was coated on a copper foil, dried, and compressed by a roll press, thus manufacturing a negative electrode having a width of 5.1 cm and a thickness of 178 μm. Between the manufactured positive and negative electrodes, a polyethylene porous film separator having a width of 5.35 cm and a thickness of 18 μm was interposed, followed by winding and placing into prismatic cans. 2.3 g of the electrolyte prepared as above were injected into the cans, thus completing the fabrication of the prismatic-type lithium secondary battery cell.

### EXAMPLE 2

A lithium secondary battery cell was prepared in the same manner as in Example 1, except that, to prepare an electrolyte, LiPF₆ and 0.25 g of 4,4-dicarboxydiphenyl sulfone as a compound additive were added to 5 g of a mixed solution of ethylene carbonate (EC)/ethyl methyl carbonate (EMC)/propylene carbonate (PC)/fluorobenzene in a volume ratio of 30/55/5/10 to form a 1.3 M LiPF₆ solution.

### EXAMPLE 3

A lithium secondary battery cell was prepared in the same manner as in Example 1, except that, to prepare an electrolyte, LiPF₆ and 0.25 g of bisphenyl sulfonyl methane as a compound additive were added to 5 g of a mixed solution of ethylene carbonate (EC)/ethyl methyl carbonate (EMC)/propylene carbonate (PC)/fluorobenzene in a volume ratio of 30/55/5/10 to form a 1.3 M LiPF₆ solution.

### EXAMPLE 4

A lithium secondary battery cell was prepared in the same manner as in Example 1, except that, to form an electrolyte, LiPF₆ and 0.25 g of methylphenyl sulfone as a compound additive were added to 5 g of a mixed solution of ethylene carbonate (EC)/ethyl methyl carbonate (EMC)/propylene carbonate (PC)/fluorobenzene in a volume ratio of 30/55/5/10 to form a 1.3 M LiPF₆ solution.

### EXAMPLE 5

A lithium secondary battery cell was prepared in the same manner as in Example 1, except that to prepare an electrolyte, LiPF₆ and 0.25 g of ethyl phenyl sulfone as a compound additive were added to 5 g of a mixed solution of ethylene carbonate (EC)/ethyl methyl carbonate (EMC)/propylene carbonate (PC)/fluorobenzene in a volume ratio of 30/55/5/10 to form a 1.3 M LiPF₆ solution.

### EXAMPLE 6

A lithium secondary battery cell was prepared in the same manner as in Example 1, except that, to prepare an electrolyte, LiPF₆ and 0.25 g of benzyl benzoate as a compound additive were added to 5 g of a mixed solution of ethylene carbonate (EC)/ethyl methyl carbonate (EMC)/propylene carbonate (PC)/fluorobenzene in a volume ratio of 30/55/5/10 to form a 1.3 M LiPF₆ solution.

### COMPARATIVE EXAMPLE 1

A lithium secondary battery cell was prepared in the same manner as in Example 1, except that, to prepare an electrolyte, LiPF₆ was added to a mixed solvent of ethylene carbonate (EC)/ethyl methyl carbonate (EMC)/propylene carbonate (PC)/fluorobenzene in a volume ratio of 30/55/5/10 to form a 1.3 M LiPF₆ solution.

The capacity of battery cells of Examples 1-6 and Comparative Example 1 were measured by charging the batteries at a 2 C rate. To evaluate safety during overcharge, lithium secondary battery cells of each of Examples 1 to 6 and Comparative Example 1 were charged with 2 A of charge current for 2.5 hours. The results are shown in Table 1.

TABLE 1

| | Standard | Capacity at | |
|---|---|---|---|
| | capacity | 2 C | |
| | (mAh) | (mAh) | Overcharge safety* |
| Example 1 | 856 | 794 | 5L0 |
| Example 2 | 841 | 779 | 5L0 |
| Example 3 | 845 | 780 | 5L0 |
| Example 4 | 843 | 782 | 5L0 |
| Example 5 | 842 | 780 | 5L0 |
| Example 6 | 841 | 779 | 5L0 |
| Comparative | 843 | 781 | 5L5 |
| Example 1 | | | |

*Note: The number preceding “L” indicates the number of tested cells.

The results of the safety test were rated as follows:

L0: effective, L1: leakage, L2: flash, L2: flame, L3: smoke, L4: ignition, L5: explosion.

As shown in Table 1, the capacity at 2 C and the overcharge safety of Examples 1-6 were better than those of the Comparative Example 1.

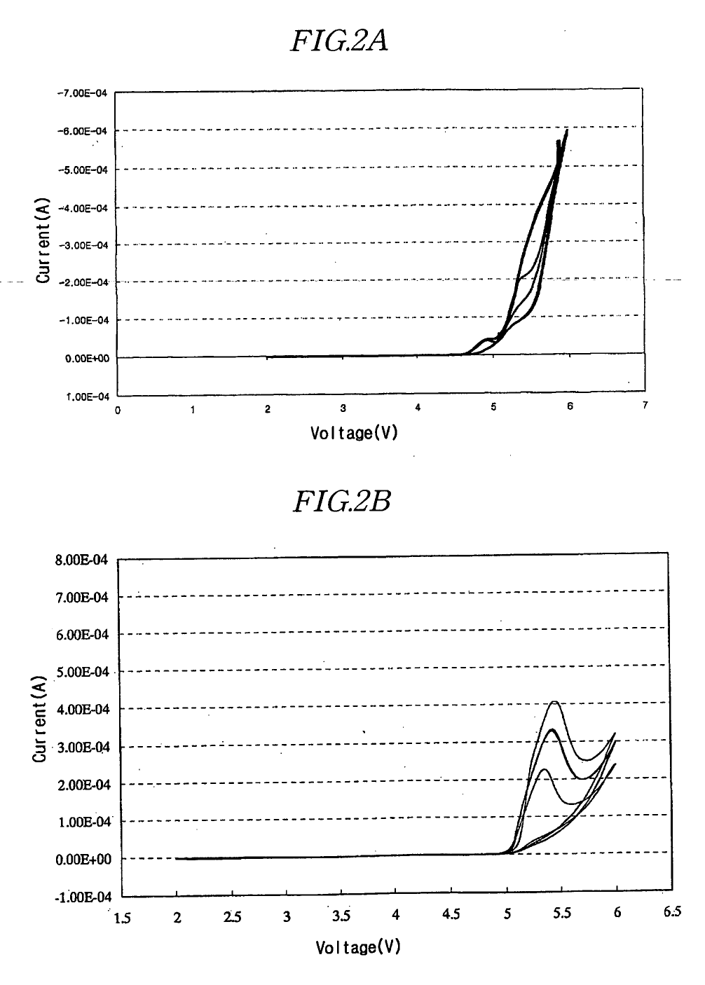

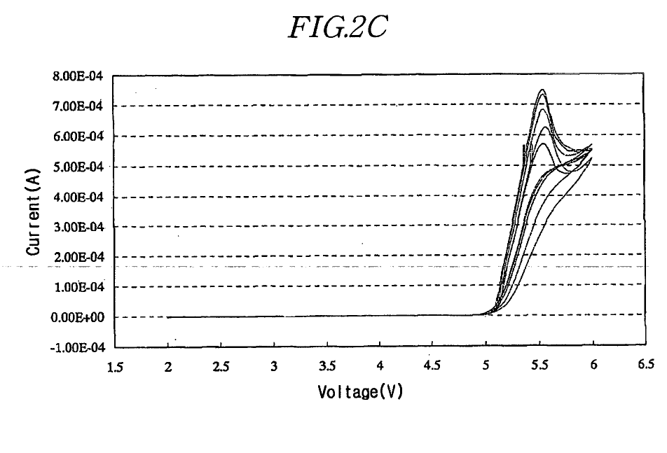

Cyclic voltammograms of the cells of Examples 1, 6 and Comparative Example 1 were studied. The cyclic voltammograms were measured in the voltage range of 2.0 V to 6.0 V at a scanning rate of 10 mwsec. Lithium metal was used as the counter electrode, and a platinum electrode was used between the working electrode and the counter electrode in the cells. FIGS. 2A to 2C show the results of Examples 1 and 6 and Comparative Example 1, respectively. As shown in FIG. 2A, decomposition peaks of the compound additive are shown at a potential of less than 5 V, indicating that the oxidation-reduction reaction of the compound additive occurs and consumes the overcharge current, and thus, contributes to the battery safety. FIG. 2B shows a current density increment according to cycling, indicating that a conductive polymer layer is formed. On the other hand, FIG. 2C shows only decomposition peaks of the electrolyte and constant current density according to cycling.

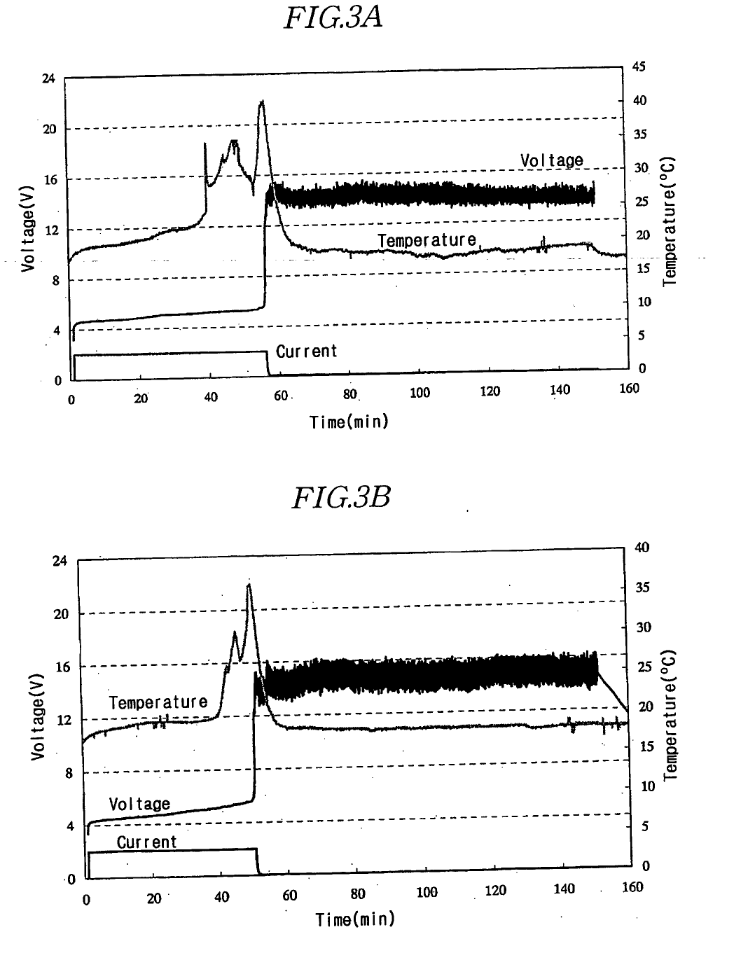

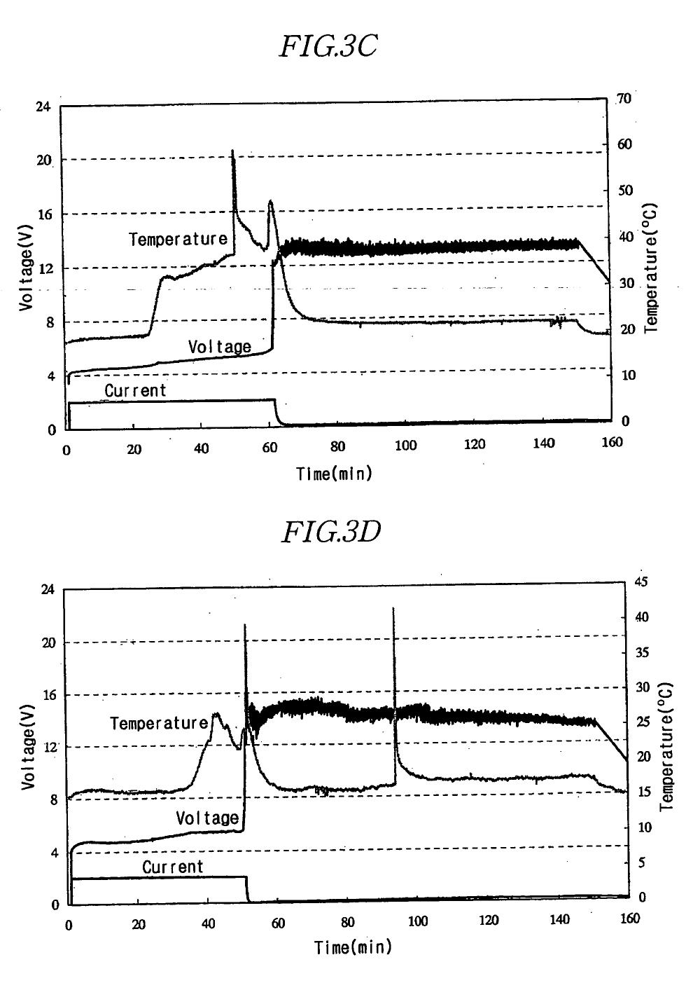

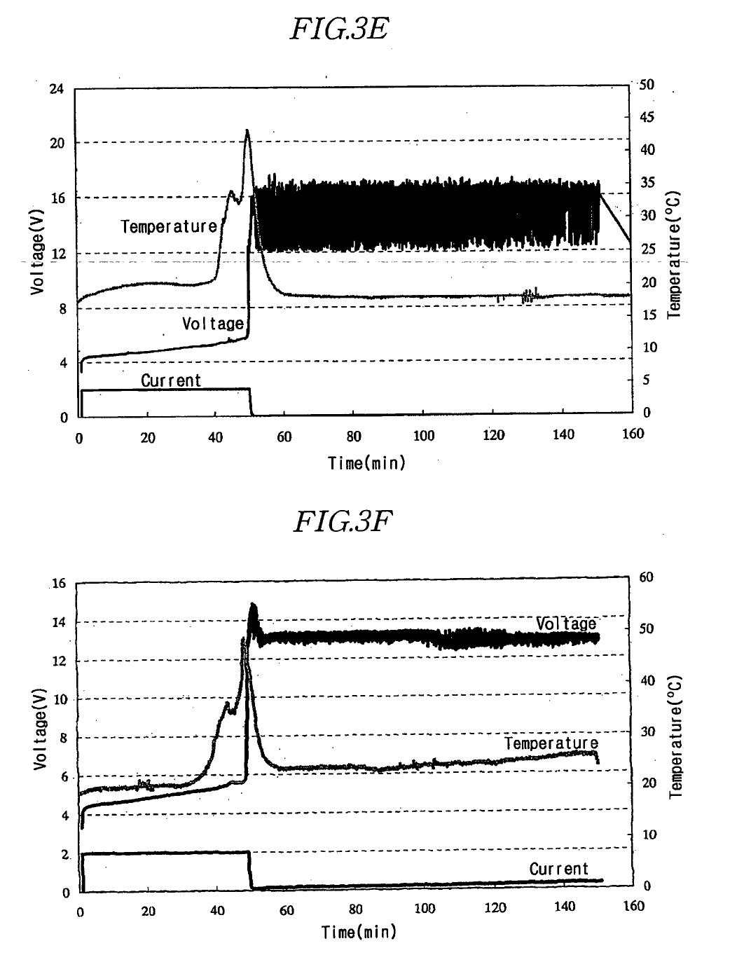

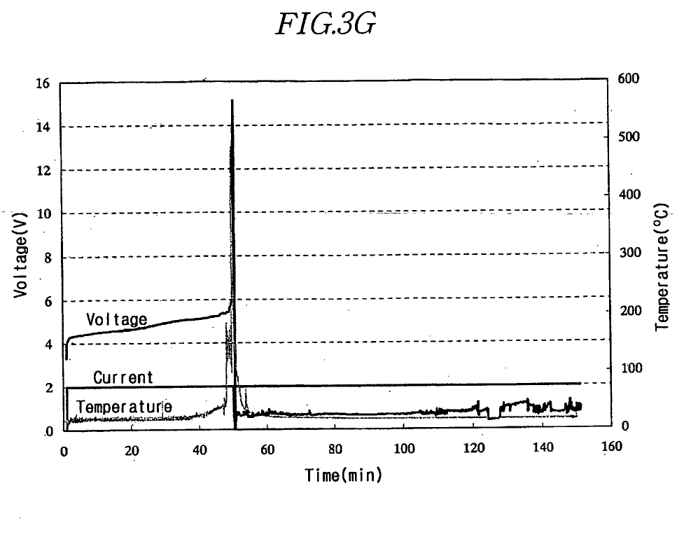

FIGS. 3A to 3E show the current, the temperature, and the voltage of the cells of Example 3 and Comparative Examples 1 and 2, respectively, when overcharging to 12 V with a current of 2 A. As shown in FIGS. 3A to 3E, the temperature of the cells of Examples 1 to 6 increased early to shut down the pores of the separator, resulting in prevention of overcharge. It is thought that the compound additives prevent the flow of the current by forming a conductive layer on the surface of the electrode. On the contrary, as shown in FIG. 3G, in the case of Comparative Example 1, the temperature rose abruptly, and the voltage dropped to 0 V at 12 V overcharging indicating that the short circuit occurred.

The lithium battery including the electrolyte of the present invention has improved electrochemical properties such as capacity at a high rate and safety of the battery during overcharge.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electrolyte of a lithium battery, comprising:
a non-aqueous organic solvent;
a lithium salt; and
a compound additive selected from the group consisting of compounds represented by the following Formulas (1) to (5) and a mixture thereof: 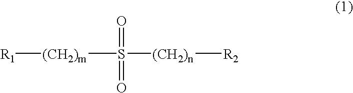
where R₁ and R₂ are independently selected from the group consisting of an alkyl and an aromatic hydrocarbon of the following formula (6), wherein if either of R₁ and R₂ is an alkyl, the other one is substantially an aromatic hydrocarbon of the following formula (6), and m and n are integers of 0 to 3, wherein m and n are not 0 simultaneously; 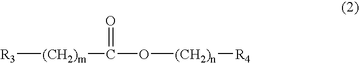
where R₃ and R₄ are independently selected from the group consisting of an alkyl and an aromatic hydrocarbon of the following formula (6), and m and n are integers of 0 to 3; 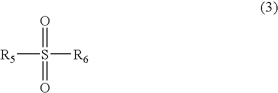
where R₅ and R₆ are independently selected from the group consisting of an alkyl and an aromatic hydrocarbon of the following formula (6), wherein if either of R₅ and R₆ is an alkyl, the other one is substantially an aromatic hydrocarbon of the following formula (6); 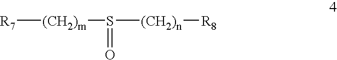
where R₇ and R₈ are independently selected from the group consisting of an alkyl and an aromatic hydrocarbon of the following formula (6), wherein if either of R₇ and R₈ is an alkyl, the other one is substantially an aromatic hydrocarbon of the following formula (6), and m and n are integers of 0 to 3; 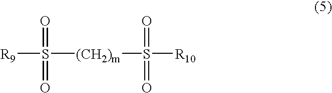
where R₉ and R₁₀ independently selected from the group consisting of an alkyl and in aromatic hydrocarbon of the following formula (6), wherein if either of R₉ and R₁₀ is an alkyl, the other one is substantially an aromatic hydrocarbon of the following formula (6), and m is a integer of 0 to 3 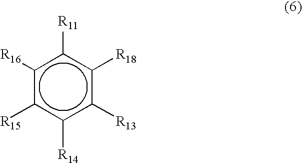
where R₁₁ and R₁₂ are independently selected from the group consisting of hydrogen, halogen, alkyl, alkoxy, hydroxy, and carboxyl.

2. The electrolyte of a lithium battery according to claim 1, wherein the compound additive is a compound selected from the group consisting of a dibenzyl sulfoxide, 4,4-dicarboxydiphenyl sulfone, bisphenyl sulfonyl methane, phenyl sulfone, bis(4-fluorophenyl) sulfone, 4-chlorophenyl phenyl sulfone, methyl phenyl sulfone, ethyl phenyl sulfone, benzyl benzoate, and mixtures thereof.

3. The electrolyte of a lithium battery according to claim 1, wherein an amount of the compound additive is 0.1 to 50 wt %.

4. The electrolyte of a lithium battery according to claim 1, wherein an amount of the compound additive is 0.1 to 5 wt %.

5. The electrolyte of a lithium battery according to claim 1, wherein the lithium salt is at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein x and y are natural fibers), LiCl, and LiI.

6. The electrolyte of a lithium battery according to claim 5, wherein the lithium salt is used in a concentration ranging from approximately 0.6 to 2.0 M.

7. The electrolyte of a lithium battery according to claim 1, wherein the non-aqueous organic solvent is at least one selected from the group consisting of a carbonate, an ester, an ether, and a ketone.

8. The electrolyte of a lithium battery according to claim 7, wherein the carbonate is selected from the group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC).

9. The electrolyte of a lithium battery according to claim 1, wherein the electrolyte comprises a mixed solvent of a cyclic carbonate and a chain carbonate.

10. The electrolyte of a lithium battery according to claim 1, wherein the electrolyte comprises a mixed solvent of a carbonate solvent and an aromatic hydrocarbon solvent.

11. The electrolyte of a lithium battery according to claim 10, wherein the aromatic hydrocarbon solvent is a compound of Formula (7): 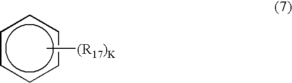
where R₁₇ is a halogen or a C₁ to C₁₀ alkyl, and k is an integer of 0 to 6.

12. The electrolyte of a lithium battery according to claim 10, wherein the aromatic hydrocarbon solvent is at least one selected from the group consisting of benzene, fluorobenzene, toluene, trifluorotoluene, and xylene.

13. The electrolyte of a lithium battery according to claim 10, wherein the carbonate solvent and the aromatic hydrocarbon solvent are mixed in a volume ratio of approximately 1:1 to 30:1.

14. A lithium battery comprising:
a positive electrode including a material to reversibly intercalate/deintercalate lithium ions as a positive active material;
a negative electrode including one of a lithium metal, a lithium-containing alloy, a material that to reversibly form a lithium-containing compound, and a material that to reversibly intercalate/deintercalate lithium ions as a negative active material;
an electrolyte,
wherein the electrolyte includes:
a non-aqueous organic solvent;
a lithium salt; and
a compound additive selected from the group consisting of compounds represented by the following Formulas (1) to (5) and a mixture thereof: 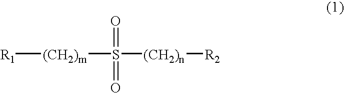
where R₁ and R₂ are independently selected from the group consisting of an alkyl and an aromatic hydrocarbon of the following formula (6), wherein if either of R₁ and R₂ is an alkyl, the other one is substantially an aromatic hydrocarbon of the following formula (6), and m and n are integers of 0 to 3 wherein m and n are not 0 simultaneously; 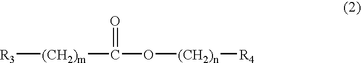
where R₃ and R₄ are independently selected from the group consisting of an alkyl and an aromatic hydrocarbon of the following formula (6), and m and n are integers of 0 to 3; 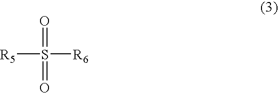
where R₅ and R₆ are independently selected from the group consisting of an alkyl and an aromatic hydrocarbon of the following formula (6), wherein if either of R₅ and R₆ is an alkyl, the other one is substantially an aromatic hydrocarbon of the following formula (6); 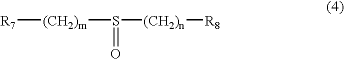
where R₇ and R₈ are independently selected from the group consisting of an alkyl and an aromatic hydrocarbon of the following formula (6), wherein if either of R₇ and R₈ is an alkyl, the other one is essentially an aromatic hydrocarbon of the following formula (6), and m and n are integers of 0 to 3; 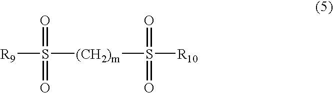
where R₉ and R₁₀ are independently selected from the group consisting of an alkyl and an aromatic hydrocarbon of the following formula (6), wherein if either of R₉ and R₁₀ is an alkyl, the other one is essentially an aromatic hydrocarbon of the following formula (6), and m and n are integers of 0 to 3; and 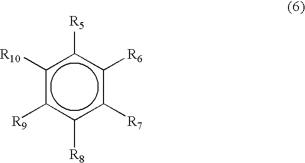
where R₁₁ and R₁₆ are independently selected from the group consisting of hydrogen, halogen, alkyl, alkoxy, hydroxy, and carboxyl.

15. A lithium battery according to claim 14, wherein the battery is one of: a lithium ion battery and a lithium polymer battery.

16. An electrolyte of a lithium battery, comprising:
a non-aqueous organic solvent;
a lithium salt; and
a compound additive selected from the group consisting of compounds represented by the following Formulas (1) to (5) and a mixture thereof: 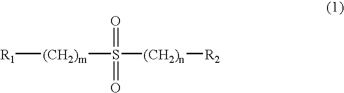
where R₁ and R₂ are independently selected from the group consisting of an alkyl and an aromatic hydrocarbon of the following formula (6), wherein if either of R₁ and R₂ is an alkyl, the other one is substantially an aromatic hydrocarbon of the following formula (6), and m and n are integers of 1 to 2, wherein m and n are not 0 simultaneously; 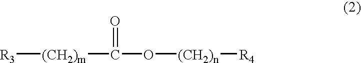
where R₃ and R₄ are independently selected from the group consisting of an alkyl and an aromatic hydrocarbon of the following formula (6), and m and n are integers of 0 to 1; 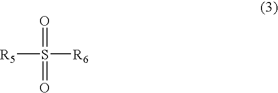
where R₅ and R₆ are independently selected from the group consisting of an alkyl and an aromatic hydrocarbon of the following formula (6), wherein if either of R₅ and R₆ is an alkyl, the other one is substantially an aromatic hydrocarbon of the following formula (6); 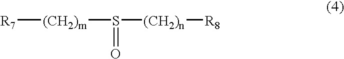
where R₇ and R₈ are independently selected from the group consisting of an alkyl and an aromatic hydrocarbon of the following formula (6), wherein if either of R₇ and R₈ is an alkyl, the other one is substantially an aromatic hydrocarbon of the following formula (6), and m and n are integers of 0 to 2; 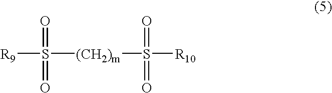
where R₉ and R₁₀ are independently selected from the group consisting of an alkyl and an aromatic hydrocarbon of the following formula (6), wherein if either of R₉ and R₁₀ is an alkyl, the other one is substantially an aromatic hydrocarbon of the following formula (6), and m is a integer of 0 to 2; and 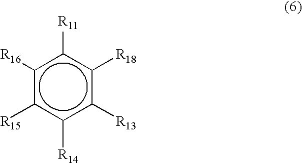
where R₁₁ and R₁₆ are independently selected from the group consisting of hydrogen, halogen, alkyl, alkoxy, hydroxy, and carboxyl.

17. A lithium battery comprising:
a positive electrode including a material to reversibly intercalate/deintercalate lithium ions as a positive active material;
a negative electrode including one of a lithium metal, a lithium-containing alloy, a material that to reversibly form a lithium-containing compound, and a material that to reversibly intercalate/deintercalate lithium ions as a negative active material;
an electrolyte,
wherein the electrolyte includes:
a non-aqueous organic solvent;
a lithium salt; and
a compound additive selected from the group consisting of compounds represented by the following Formulas (1) to (5) and a mixture thereof: 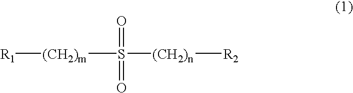
where R₁ and R₂ are independently selected from the group consisting of an alkyl and an aromatic hydrocarbon of the following formula (6), wherein if either of R₁ and R₂ is an alkyl, the other one is substantially an aromatic hydrocarbon of the following formula (6), and m and n are integers of 1 to 2, wherein m and n are not 0 simultaneously; 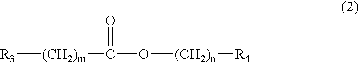
where R₃ and R₄ are independently selected from the group consisting of an alkyl and an aromatic hydrocarbon of the following formula (6), and m and n are integers of 0 to 3; 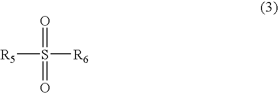
where R₅ and R₆ are independently selected from the group consisting of an alkyl and an aromatic hydrocarbon of the following formula (6), wherein if either of R₅ and R₆ is an alkyl, the other one is substantially an aromatic hydrocarbon of the following formula (6); 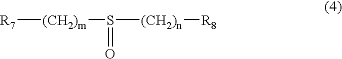
where R₇ and R₈ are independently selected from the group consisting of an alkyl and an aromatic hydrocarbon of the following formula (6), wherein if either of R₇ and R₈ is an alkyl, the other one is substantially an aromatic hydrocarbon of the following formula (6), and m and n are integers of 0 to 3; 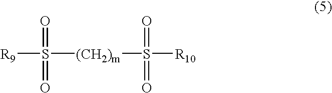
where R₉ and R₁₀ are independently selected from the group consisting of an alkyl and an aromatic hydrocarbon of the following formula (6), wherein if either of R₉ and R₁₀ is an alkyl, the other one is substantially an aromatic hydrocarbon of the following formula (6), and m and n are integers of 0 to 3; 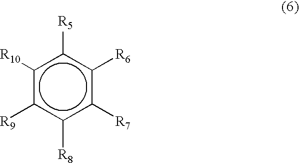
where R₁₁ and R₁₆ are independently selected from the group consisting of hydrogen, halogen, alkyl, alkoxy, hydroxy, and carboxyl.
